(19) United States
(12) Patent Application Publication
(10) Pub. No.: US 2025/0159514 A1
(43) Pub. Date: May 15, 2025

(54) NETWORK NODE ENERGY USAGE REPORTING

(71) Applicant: QUALCOMM Incorporated, San Diego, CA (US)

(72) Inventors: Naeem AKL, Bridgewater, NJ (US); Navid ABEDINI, Basking Ridge, NJ (US)

(21) Appl. No.: 18/506,412

(22) Filed: Nov. 10, 2023

(51) Int. Cl. H04W 24/10

(52) U.S. Cl. CPC H04W 24/10

(57) ABSTRACT

Various aspects of the present disclosure generally relate to wireless communication. In some aspects, a network node may receive an energy usage monitoring configuration associated with service of a user equipment (UE). The network node may transmit to the UE, or receive from the UE, one or more transmissions. The network node may transmit, based at least in part on the one or more transmissions, an energy usage report associated with the energy usage monitoring configuration. Numerous other aspects are described.

### FIELD OF THE DISCLOSURE

Aspects of the present disclosure generally relate to wireless communication and to techniques and apparatuses for energy usage reporting by a network node.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include one or more memories and one or more processors coupled to the one or more memories. The one or more processors may be configured, individually or in any combination, to receive an energy usage monitoring configuration associated with service of a user equipment (UE). The one or more processors may be configured, individually or in any combination, to transmit to the UE, or receive from the UE, one or more transmissions. The one or more processors may be configured, individually or in any combination, to transmit, based at least in part on the one or more transmissions, an energy usage report associated with the energy usage monitoring configuration.

Some aspects described herein relate to a method of wireless communication performed by a network node. The method may include receiving an energy usage monitoring configuration associated with service of a UE. The method may include transmitting to the UE, or receiving from the UE, one or more transmissions. The method may include transmitting, based at least in part on the one or more transmissions, an energy usage report associated with the energy usage monitoring configuration.

Some aspects described herein relate to a non-transitory computer-readable medium that stores a set of instructions for wireless communication by a network node. The set of instructions, when executed by one or more processors of the network node, may cause the network node to receive an energy usage monitoring configuration associated with service of a UE. The set of instructions, when executed by one or more processors of the network node, may cause the network node to transmit to the UE, or receive from the UE, one or more transmissions. The set of instructions, when executed by one or more processors of the network node, may cause the network node to transmit, based at least in part on the one or more transmissions, an energy usage report associated with the energy usage monitoring configuration.

Some aspects described herein relate to an apparatus for wireless communication. The apparatus may include means for receiving an energy usage monitoring configuration associated with service of a UE. The apparatus may include means for transmitting to the UE, or means for receiving from the UE, one or more transmissions. The apparatus may include means for transmitting, based at least in part on the one or more transmissions, an energy usage report associated with the energy usage monitoring configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a 5G network architecture that supports a wireless telecommunications system for data services, in accordance with the present disclosure.

FIG. 5 is a diagram illustrating an example of network node energy usage reporting, in accordance with the present disclosure.

FIG. 6 is a diagram illustrating an example of an energy usage reporting process, in accordance with the present disclosure.

FIG. 7 is a diagram illustrating an example of a 5G network architecture that supports network node energy usage reporting, in accordance with the present disclosure.

FIG. 8 is a diagram illustrating an example of an energy usage reporting process involving a decomposed radio access network (RAN), in accordance with the present disclosure.

FIG. 9 is a diagram illustrating examples associated with reported energy usage information, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

### DETAILED DESCRIPTION

The topic of energy efficiency in communication networks is garnering increasing interest from network operators, standards organizations, the networking industry at large, and governmental bodies, and efforts are underway to offer energy efficiency as a service. Energy efficiency as a service allows a user equipment (UE) to receive a network service in an energy-efficient manner. For example, the UE may be authorized to consume a given amount of energy while using the network service for a given period of time. However, energy efficiency as a service may be unable to handle energy usage without certain energy usage information. For example, the energy efficiency as a service may be unable to monitor, or charge based on, energy consumed by a UE without information indicating how the UE is consuming the energy (e.g., an amount of energy consumed by the UE).

Various aspects relate generally to energy usage reporting. Some aspects more specifically relate to a control-plane-based solution for energy efficiency reporting. In some examples, a network node may receive, from a network entity (e.g., an access and mobility management function (AMF) or a session management function (SMF)), an energy usage monitoring configuration and/or an indication of an energy usage threshold. For example, the energy usage monitoring configuration may configure the network node to apply energy usage monitoring, and the energy usage threshold may apply to a UE. The network node may transmit to the UE, or receive from the UE, one or more transmissions (e.g., downlink and/or uplink messages).

The network node may transmit, to the network entity, an energy usage report associated with the energy usage monitoring configuration. For example, the network node may inform the AMF and/or the SMF that energy usage monitoring has been configured or cannot be configured. The network node may report (e.g., to the AMF and/or the SMF) energy usage using the energy usage report based on the one or more transmissions. In some examples, the energy usage report may indicate one or more of a level of granularity associated with the energy usage report, a time associated with the energy usage report, or a triggering event associated with the energy usage report.

Particular aspects of the subject matter described in this disclosure can be implemented to realize one or more of the following potential advantages. In some examples, by transmitting the energy usage report, the described techniques can be used to provide control-plane-based energy efficiency reporting, thereby enabling an energy efficiency as a service. For example, the network node may transmit the energy usage report in the control plane, which may avoid (or reduce) impact on the user plane, which may include certain data carried between the UE and the data network via the network node and a user plane function (UPF).

Receiving the indication of the energy usage threshold may enable the network node to, based on the energy usage threshold, take one or more networking actions, such as reporting that the energy consumed by the UE has satisfied (or will satisfy) the energy usage threshold. The energy usage report indicating information including one or more of a level of granularity associated with the energy usage report, a time associated with the energy usage report, or a triggering event associated with the energy usage report may enable the network entity to, based on that information, perform robust functions (e.g., energy usage monitoring and/or charging).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

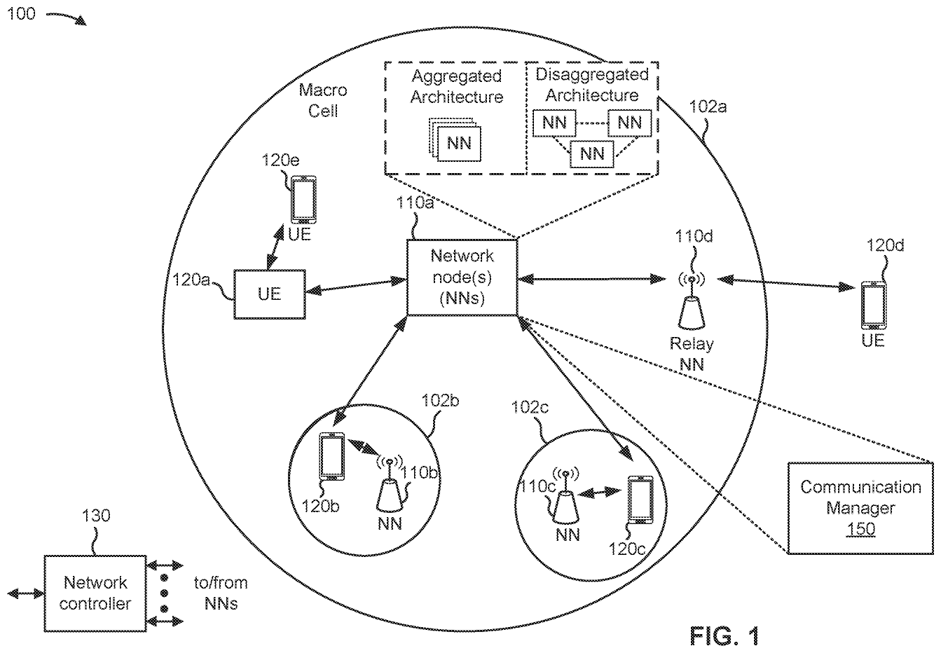

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may receive an energy usage monitoring configuration associated with service of the UE 120; transmit to the UE 120, or receive from the UE 120, one or more transmissions; and transmit, based at least in part on the one or more transmissions, an energy usage report associated with the energy usage monitoring configuration. Additionally, or alternatively, the communication manager 150 may perform one or more other operations described herein.

As indicated above, FIG. 1 is provided as an example. Other examples may differ from what is described with regard to FIG. 1.

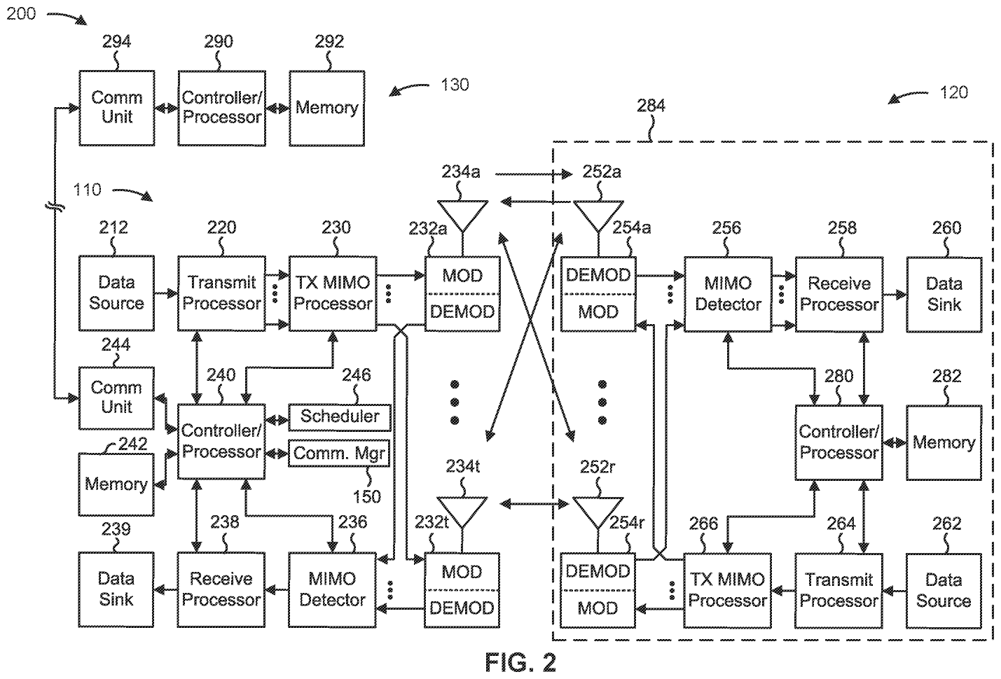

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

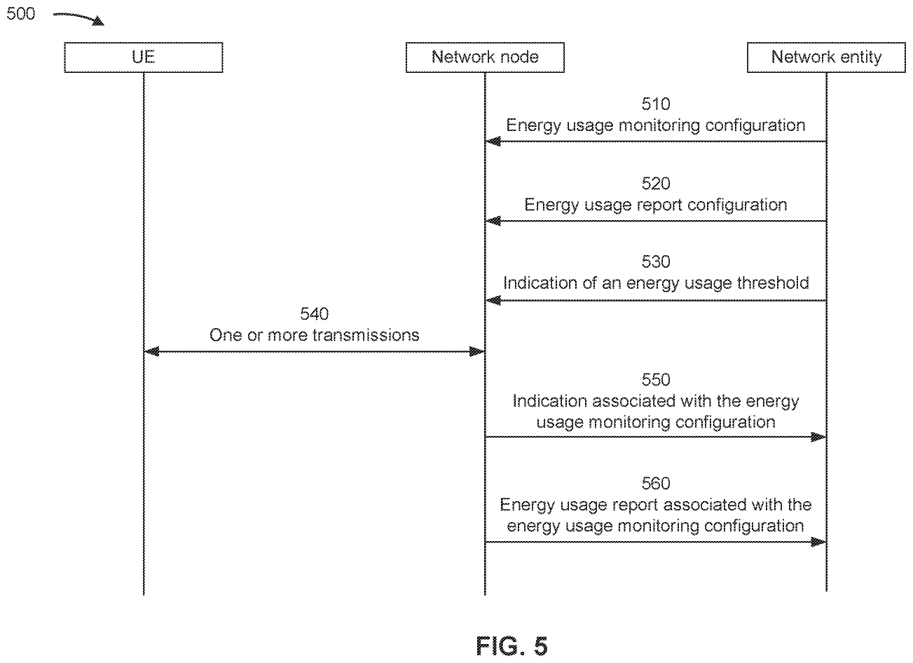

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

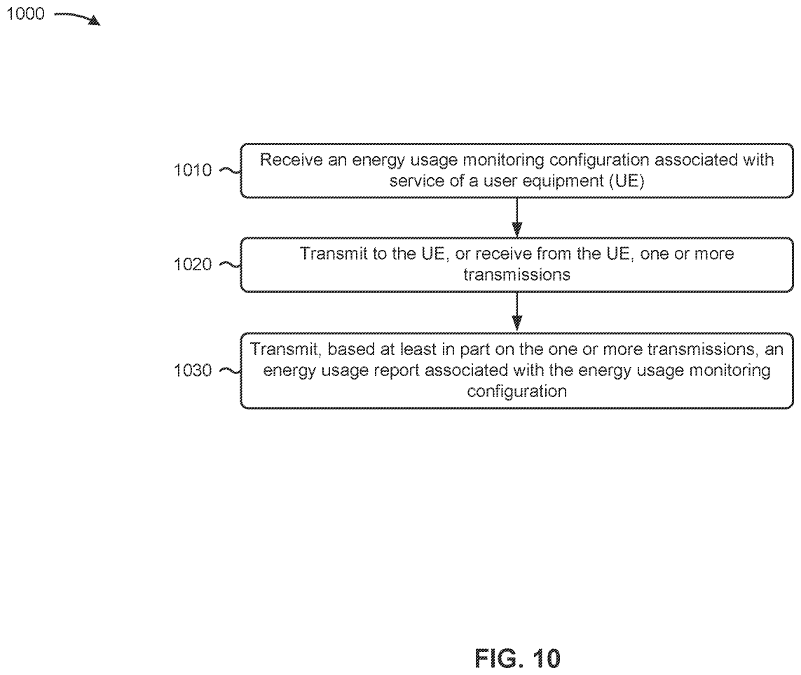

The controller/processor 240 of the network node 110, the controller/processor 280 of the UE 120, and/or any other component(s) of FIG. 2 may perform one or more techniques associated with energy usage reporting by a network node, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10 and/or other processes as described herein. In some examples, executing instructions may include running the instructions, converting the instructions, compiling the instructions, and/or interpreting the instructions, among other examples.

In some aspects, the network node 110 includes means for receiving an energy usage monitoring configuration associated with service of the UE 120; means for transmitting to the UE 120, or receiving from the UE 120, one or more transmissions; and/or means for transmitting, based at least in part on the one or more transmissions, an energy usage report associated with the energy usage monitoring configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

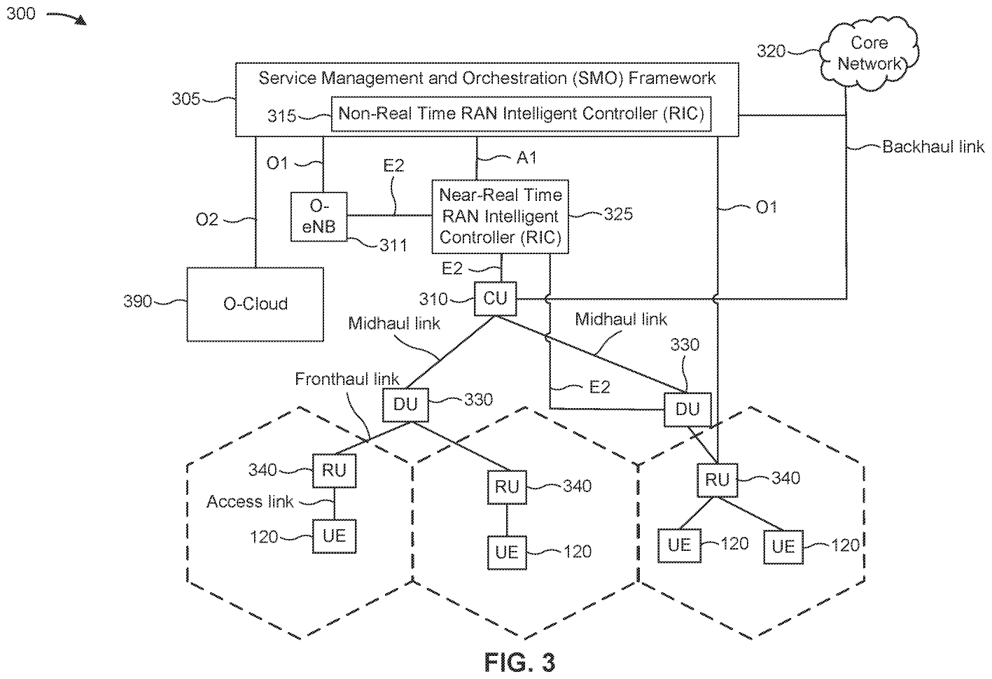

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325.

The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

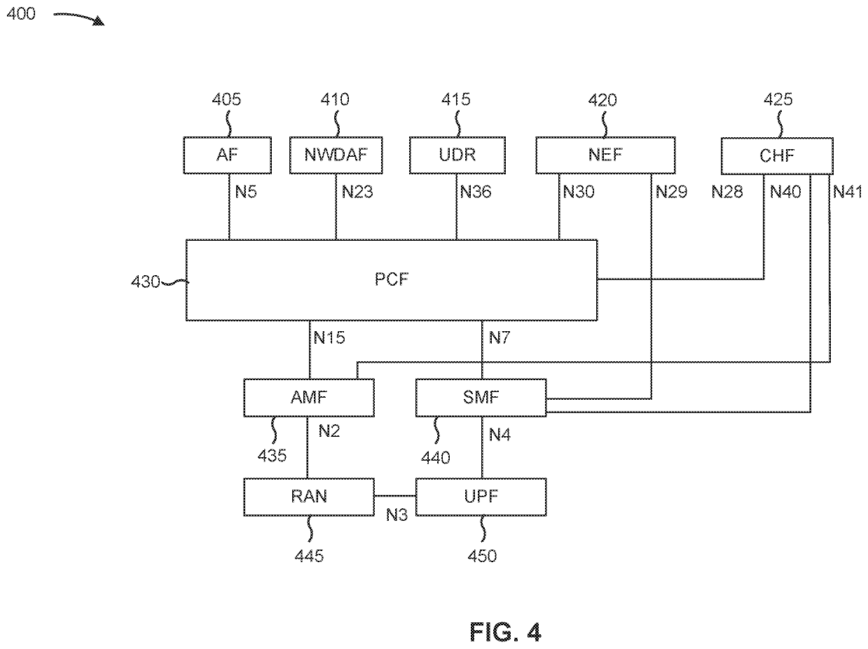

FIG. 4 is a diagram illustrating an example 400 of a 5G network architecture that supports a wireless telecommunications system for data services, in accordance with the present disclosure.

The 5G network architecture includes an application function (AF) 405, a network data analytics function (NWDAF) 410, a unified data repository (UDR) 415, a network exposure function (NEF) 420, a charging function (CHF) 425, a policy control function (PCF) 430, an AMF 435, an SMF 440, a RAN 445, and a UPF 450.

The AF 405 includes one or more devices that support application influence on traffic routing, access to the NEF 420, and/or policy control, among other examples.

The NWDAF 410 includes one or more devices that support data collection and analysis associated with the wireless telecommunications system.

The UDR 415 includes one or more devices that support storage of subscription information (e.g., in a centralized database).

The NEF 420 includes one or more devices that support exposure of capabilities and/or events in the wireless telecommunications system to help other entities in the wireless telecommunications system discover network services.

The CHF 425 includes one or more devices that support usage data collection and billing. The CHF 425 may grant credit to the SMF 440. For example, interactions between the SMF 440 and the CHF 425 may be based on credits. For example, the CHF 425 may credit, to the SMF 440, a given quantity of bits that a UE may consume in a particular protocol data unit (PDU) session. The SMF 440 may be triggered, at the expiry of the credit, to report to the CHF 425 that the given quantity of bits has been consumed by the UE. The CHF may then determine whether to report additional credit to the SMF 440 or terminate service for the UE.

The PCF 430 includes one or more devices that provide a policy framework that incorporates network slicing, roaming, packet processing, and/or mobility management, among other examples. For example, the PCF 430 may configure one or more policies on the AMF 435 and/or the SMF 440. For example, interactions between the SMF 440 and the CHF 425 may be based on policy.

The AMF 435 includes one or more devices that act as a termination point for non-access stratum (NAS) signaling and/or mobility management, among other examples. The AMF 435 may provide, to the RAN 445, indications of UE and/or slice caps (e.g., per-UE or per-network-slice maximum usage thresholds).

The SMF 440 includes one or more devices that support the establishment, modification, and release of communication sessions in the wireless telecommunications system. For example, the SMF 440 may configure traffic steering policies at the UPF 450 and/or may enforce UE internet protocol (IP) address allocation and policies, among other examples. The SMF 440 may provide PDU session and/or QoS flow configurations to the RAN 445 and/or the UPF 450. The SMF 440 may report data usage to the PCF 430 for usage monitoring and/or to the CHF 425 for charging.

The RAN 445 may include one or more network nodes (e.g., network node 110).

The UPF 450 includes one or more devices that serve as an anchor point for intra-RAT and/or inter-RAT mobility. The UPF 450 may apply rules to packets, such as rules pertaining to packet routing, traffic reporting, and/or handling user plane QoS, among other examples. The UPF 450 may report served data to the SMF 440 on a per-PDU-session, per-service-data-flow, and/or per-QoS-flow basis.

A UE may access a data network via the RAN 445 and the UPF 450. For example, the UE may establish a PDU session with the data network via the RAN 445 and the UPF 450. The UPF 450 and the data network may transport data within the PDU session via one or more service data flows (SDFs). For example, in a streaming use case, the PDU session may be associated with one data SDF and one voice SDF. The RAN 445 and the UPF 450 may transport data within the PDU session via one or more QoS flows associated with one or more of the SDFs. The UE may support up to 256 PDU sessions.

As indicated above, FIG. 4 is provided as an example. Other examples may differ from what is described with respect to FIG. 4.

The topic of energy efficiency in communication networks is garnering increasing interest from network operators, standards organizations, the networking industry at large, and governmental bodies, particularly in the 6G context, and efforts are underway to offer energy efficiency as a service. Energy efficiency as a service allows a UE to receive a network service in an energy-efficient manner, thereby offering improvements in the sustainability and green networks spaces. For example, the UE may be authorized to consume a given amount of energy while using the network service for a given period of time. However, energy efficiency as a service may be unable to handle energy usage without certain energy usage information. For example, the energy efficiency as a service may be unable to monitor, or charge based on, energy consumed by a UE without information indicating how the UE is consuming the energy (e.g., an amount of energy consumed by the UE).

FIG. 5 is a diagram illustrating an example 500 of network node energy usage reporting, in accordance with the present disclosure. Example 500 involves communications between a UE (e.g., UE 120), a network node (e.g., network node 110), and a network entity (e.g., a core network entity, such as an AMF or an SMF).

As shown by reference number 510, the network entity may transmit, and the network node may receive, an energy usage monitoring configuration associated with service of the UE. For example, the network node may receive the energy usage monitoring configuration (e.g., associated with the UE) from the AMF and/or the SMF. The energy usage monitoring configuration may configure the network node to apply energy usage monitoring. For example, the energy usage monitoring configuration may configure the network node for energy usage monitoring with respect to energy that is consumed to serve the UE or provide a particular service to the UE. In some examples, the energy usage monitoring configuration may configure the network node to apply energy usage monitoring at a corresponding level of granularity (e.g., UE-level granularity, network-slice-level granularity, PDU-session-level granularity, QoS-flow-level granularity, or the like).

As shown by reference number 520, the network entity may transmit, and the network node may receive, an energy usage report configuration (e.g., a reporting configuration). For example, the network node may receive a configuration from the AMF and/or the SMF. The energy usage report configuration may configure the network node to send energy usage reports. For example, the energy usage report configuration may configure the network node to report energy usage to the network entity.

The energy usage report configuration may indicate a granularity of the reporting, an event for the reporting, and/or a periodicity of the reporting. In some examples, the energy usage report configuration may configure the network node to send the energy usage reports at a corresponding level of granularity (e.g., UE-level granularity, network-slice-level granularity, PDU-session-level granularity, QoS-flow-level granularity, or the like). In some examples, the energy usage report configuration may configure the network node to send the energy usage reports in response to the occurrence of a triggering event and/or with a given periodicity.

As shown by reference number 530, the network entity may transmit, and the network node may receive, an indication (e.g., a “threshold indication”) of an energy usage threshold associated with the energy usage monitoring configuration. For example, the network node may receive the energy usage threshold (e.g., an energy cap, a limit, an energy usage value (e.g., an authorized energy usage value, a requested energy usage, or the like) from the AMF or the SMF. The energy usage threshold may be associated with (e.g., apply to) the UE. The network node may, based on an ability of the network node to maintain a requested energy usage for the UE, admit service to the UE (e.g., establish a connection, perform PDU session setup and/or modification, perform QoS flow setup and/or modification, serve the UE on a given network slice, or the like).

In some aspects, the energy usage threshold may be specific to the UE. For example, the network node may receive the energy cap from the AMF (e.g., based on an energy usage policy or subscription information) on a per-UE basis. For example, the authorized energy usage value may be per-UE.

In some aspects, the energy usage threshold may be specific to a network slice that is associated with the UE. For example, the network node may receive the energy cap from the AMF (e.g., based on an energy usage policy or subscription information) on a per-network-slice basis. For example, the authorized energy usage value may be for a network slice.

In some aspects, the energy usage threshold may be specific to a PDU session. For example, the network node may receive the energy cap from the AMF (e.g., based on an energy usage policy or subscription information) on a per-PDU-session basis. For example, the authorized energy usage value may be for a PDU session.

In some aspects, the energy usage threshold may be specific to a QoS flow. For example, the network node may receive the energy cap from the AMF (e.g., based on an energy usage policy or subscription information) on a per-QoS-flow basis. For example, the authorized energy usage value may be for a QoS flow.

The network node may receive downstream information from the network entity (e.g., the energy usage monitoring configuration, the energy usage report configuration, and/or the indication of the energy usage threshold) in any suitable quantity of requests. For example, the network node may receive a request to monitor energy usage for a UE, and the request may include an indication of the granularity for energy usage and a request to report energy usage.

As shown by reference number 540, the network node may transmit to the UE, or receive from the UE, one or more transmissions. For example, the network node may provide a service to the UE by exchanging transmissions (e.g., downlink and/or uplink messages) with the UE. In some examples, the network node may provide the service to the UE based on the received authorized energy usage value (e.g., for the indicated level of granularity).

As shown by reference number 550, the network node may transmit, and the network entity may receive, an indication associated with the energy usage monitoring configuration. For example, the network node may inform the AMF and/or the SMF that energy usage monitoring has been configured or cannot be configured. For example, the network node may accept or reject monitoring of energy usage for the UE. For example, the network node may transmit an indication acknowledging or admitting a request to monitor energy usage conveyed by the energy usage monitoring configuration. In some examples (e.g., where energy usage monitoring has been accepted/configured), the network node may further inform the AMF and/or the SMF of the corresponding granularity.

As shown by reference number 560, the network node may transmit, and the network entity may receive, based at least in part on the one or more transmissions, an energy usage report associated with the energy usage monitoring configuration. The network node may report energy usage using the energy usage report. For example, the network node may send energy reports to the AMF and/or the SMF. The energy usage report may be associated with the energy usage monitoring configuration in that the energy usage monitoring configuration may configure the network node to perform energy usage monitoring, which may involve transmitting the energy usage report.

In some aspects, the energy usage report may be associated with the energy usage report configuration. For example, the energy usage report may be associated with the energy usage report configuration in that the energy usage report may be transmitted in accordance with one or more parameters specified by the energy usage report configuration (e.g., level of granularity, triggering event, periodicity, or the like). For example, the network node may report a list including consumed data rates with associated energy usage modes for a given granularity.

In some aspects, the energy usage report may indicate one or more of a level of granularity associated with the energy usage report, a time associated with the energy usage report, or a triggering event associated with the energy usage report. In some examples, the network node may send energy reports (e.g., energy usage reports) to the AMF and/or the SMF with a corresponding granularity. For example, the energy usage report may include an indication of granularity. In some examples, the network node may indicate (e.g., in the energy usage report) the trigger based on which energy usage report was initiated (e.g., a triggering event for the energy usage report). For example, the energy usage report may include a report trigger (e.g., a trigger based on which the energy report was initiated). In some examples, the energy usage report may include an associated time (e.g., a time at which the energy usage report was generated).

In some aspects, the network node may transmit the energy usage report based at least in part on one or more of a start of a mode of service, or an energy usage associated with the UE satisfying an energy usage threshold. For example, triggering events that prompt the network node to transmit the energy usage report may include a start of a mode of operation to serve the UE or the energy usage reaching a limit. A mode of operation (or mode of service) may be a mode in which the network node uses one or more network energy saving techniques. For example, the energy usage may be measured in time, energy units, an energy-usage-normalized data rate, or the like, and the limit may be at any suitable level of granularity (e.g., per PDU session, on one or more SDFs or QoS flows, or the like).

In some aspects, the energy usage report may be specific to the UE, a network slice associated with the UE, a PDU session associated with the UE, or a QoS flow associated with the UE. For example, in a case where the network entity is the SMF, the energy usage report may be QoS-flow-specific or PDU-session-specific. In a case where the network entity is the AMF, the energy usage report may be slice-specific or UE-specific.

The network node may transmit any suitable upstream information (e.g., in addition to, or instead of, an indication that the request to monitor the energy usage has been admitted or accepted (e.g., for a specific level of granularity), the energy usage report, or the like). For example, the network node may indicate the activation or deactivation of a mode of energy usage for the UE. For example, the indication of the activation or deactivation of the mode of energy usage may indicate a granularity, a time of the activation or deactivation, a change in the mode of energy usage, or the like. Additionally, or alternatively, the network node may indicate a failure to maintain the requested energy usage for the UE. Additionally, or alternatively, the network node may provide an alternative energy usage value for the UE that can be supported. Additionally, or alternatively, the network node may inform the AMF and/or the SMF of an alternative energy cap that has been applied to the UE (and the corresponding granularity). Additionally, or alternatively, the network node may indicate resumption of maintaining the requested energy usage for the UE. Additionally, or alternatively, the network node may report that the energy usage reached/exceeded the limit. For example, the network node may inform the AMF and/or the SMF whether the energy cap is violated. Additionally, or alternatively, the network node may inform the AMF and/or the SMF whether the energy cap can be met. In some examples, the network node may provide an implicit indication that the energy cap can be met (e.g., the indication may be that the UE connection has not been released).

In some examples, the network node may provide or change the service to the UE based on consumed energy usage. Additionally, or alternatively, the network node may provide or change the service to the UE based on a configuration received from the AMF, the SMF, a PCF, or the like. For example, the configuration may be the energy usage monitoring configuration or a separate configuration.

Transmitting the energy usage report may enable the network node to use a control-plane-based solution for energy efficiency reporting. For example, the network node may transmit the energy usage report in the control plane, thereby minimizing impact on the user plane (e.g., certain data carried between the UE and the data network via the network node and a UPF). Transmitting the energy usage report in the control plane may enable an energy consumption information exchange framework. The framework may enable 5G core (5GC) network functions and/or the RAN to provide energy consumption reports on a per-slice basis, per-PDU-session basis, per-QoS-flow basis, or the like. Additionally, or alternatively, the framework may introduce a maximum energy credit limit as a policy per service, energy consumption information in CDRs (e.g., for charging purposes), and/or energy efficiency modes in policy information; offer energy efficiency as a service to application functions and subscribers; cap energy consumed for specific services at a given energy consumption rate in the network; charge based on energy consumption (e.g., increased pricing above a given energy consumption rate); define different energy efficiency modes; and/or compute energy consumption on a per-network-slice basis, a per-PDU-session basis, a per-QoS-flow basis, or the like.

Receiving the indication of the energy usage threshold may enable the network node to, based on the energy usage threshold, take one or more networking actions, such as reporting that the energy consumed by the UE has satisfied (or will satisfy) the energy usage threshold. The energy usage report indicating information including one or more of a level of granularity associated with the energy usage report, a time associated with the energy usage report, or a triggering event associated with the energy usage report may enable the network entity to, based on that information, perform robust functions (e.g., energy usage monitoring and/or charging). The energy usage report being specific to a target level of granularity (e.g., the UE, a network slice associated with the UE, a PDU session associated with the UE, or a QoS flow associated with the UE) may enable the network node to report the energy consumed by the UE at the target level of granularity.

As indicated above, FIG. 5 is provided as an example. Other examples may differ from what is described with respect to FIG. 5.

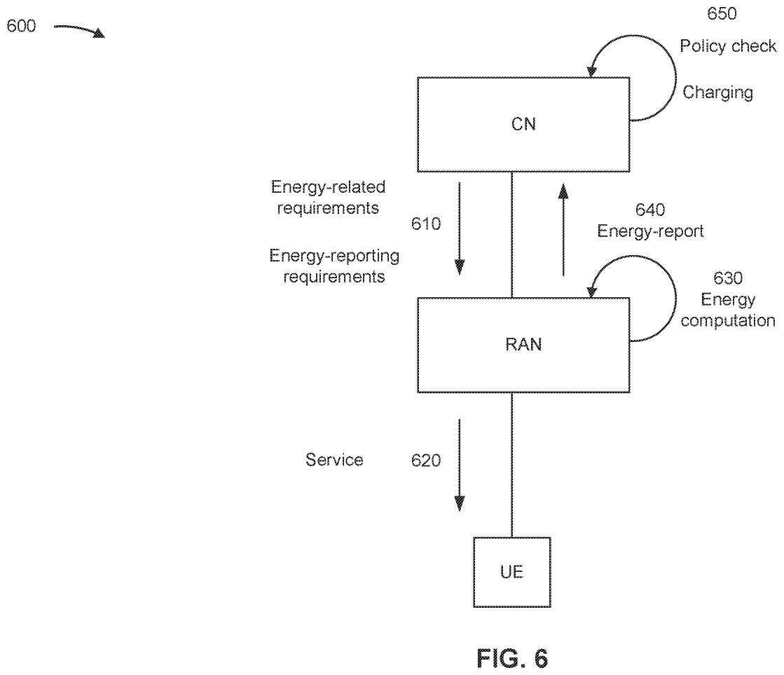

FIG. 6 is a diagram illustrating an example 600 of an energy usage reporting process, in accordance with the present disclosure. Example 600 involves communications between a core network (“CN”), a RAN, and a UE. The core network may include various network entities, such as an AMF, an SMF, a PCF, a CHF, and/or the like. The RAN may include one or more network nodes (e.g., network node 110). The UE may be connected to, and accessing services via, the RAN.

As shown by reference number 610, the core network may transmit, and the RAN may receive, an energy usage policy (e.g., requirements relating to energy usage or energy usage reporting). As shown by reference number 620, the RAN provides a service to the UE. As shown by reference number 630, the RAN performs an energy computation based on the energy usage policy. As shown by reference number 640, the RAN transmits (e.g., sends), and the core network receives, an energy report. As shown by reference number 650, the core network performs a check on an energy usage policy and/or implements charging based on the energy report received from the RAN.

As indicated above, FIG. 6 is provided as an example. Other examples may differ from what is described with respect to FIG. 6.

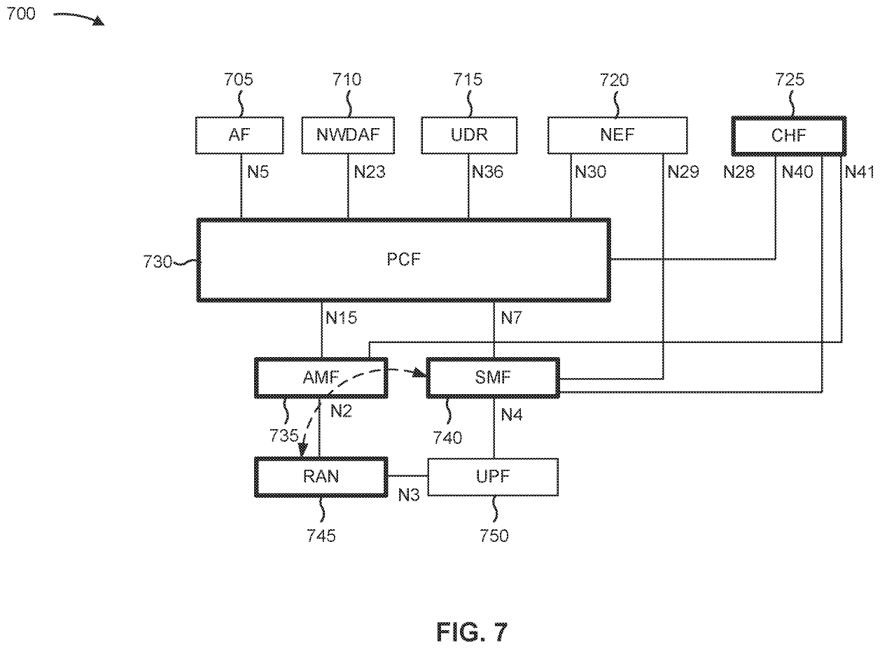

FIG. 7 is a diagram illustrating an example 700 of a 5G network architecture that supports network node energy usage reporting, in accordance with the present disclosure. The 5G network architecture includes various network entities, including an AF 705, an NWDAF 710, a UDR 715, an NEF 720, a CHF 725, a PCF 730, an AMF 735, an SMF 740, a RAN 745, and a UPF 750. The 5G network architecture further includes interfaces (e.g., N5, N23, N36, and so forth) that enable communications between the network entities.

Example 700 may generally involve communications between the AMF 735, SMF 740, and/or RAN 745. For example, communications may occur between the RAN 745 and the AMF 735 (e.g., via N2), and/or communications may occur between the RAN 745 and the SMF 740 via the AMF 735.

The RAN 745 may receive downlink information from the AMF 735 and/or from the SMF 740 via the AMF 735. For example, the RAN 745 may receive the energy usage monitoring configuration (e.g., a request to monitor energy usage), the energy usage report configuration, and/or the indication of the energy usage threshold (e.g., the authorized energy usage value) from the AMF 735 and/or from the SMF 740 via the AMF 735.

The RAN 745 may transmit uplink information to the AMF 735 and/or to the SMF 740 via the AMF 735. For example, the RAN 745 may transmit the indication associated with the energy usage monitoring configuration and/or the energy usage report to the AMF 735 and/or to the SMF 740 via the AMF 735. For example, the RAN 745 may carry out reporting to the AMF 735 and/or to the SMF 740 via the AMF 735.

As indicated above, FIG. 7 is provided as an example. Other examples may differ from what is described with respect to FIG. 7.

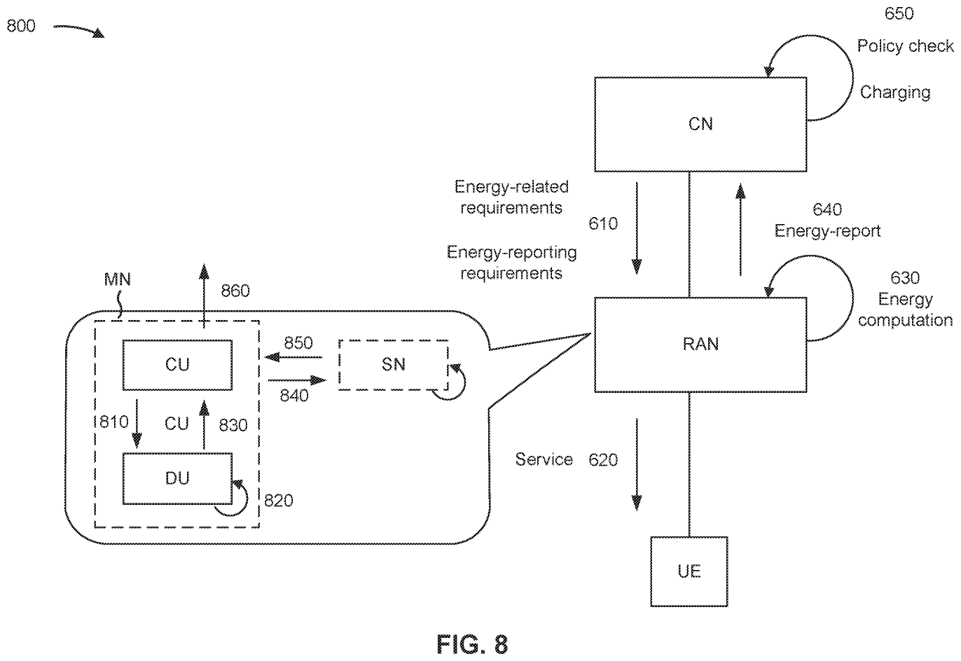

FIG. 8 is a diagram illustrating an example 800 of an energy usage reporting process involving a decomposed RAN, in accordance with the present disclosure. The decomposed RAN may include a CU, a DU, a master node (MN), and/or a secondary node (SN). In some examples, the decomposed RAN may include a network node (e.g., network node 110) that contains at least one CU and at least one DU (e.g., among a set of DUs). In some examples, the network node may be a master node, and another network node in the decomposed RAN may be a secondary node.

As shown by reference number 610, the core network may transmit, and the decomposed RAN may receive, an energy usage policy (e.g., requirements relating to energy usage or energy usage reporting). As shown by reference number 620, the decomposed RAN provides a service to the UE. As shown by reference number 630, the decomposed RAN performs an energy computation based on the energy usage policy. As shown by reference number 640, the decomposed RAN transmits, and the core network receives, an energy report. As shown by reference number 650, the core network performs a check on an energy usage policy and/or implements charging based on the energy report received from the decomposed RAN.

As shown by reference number 810, the CU may transmit, to the DU, downstream information based at least in part on the energy usage monitoring configuration and/or the energy usage report configuration. For example, the CU (e.g., CU control plane (CU-CP) may transmit, to the DU, a request to monitor energy usage (and/or at a specified level of granularity), and the DU may accept or reject the request. The downstream information may be relayed from the core network by the CU to the DU.

In some examples, the CU may provide a subset of information received from the core network to the DU. For example, the CU may receive energy usage monitoring configurations for every QoS flow, and the CU may forward a subset of the energy usage monitoring configurations based on which QoS flow(s) the DU is handling. In some examples, the granularity in the downstream information may vary (e.g., the CU may convert the granularity from a QoS flow to a data radio bearer (DRB), or the like). The granularity may be per-UE, per-DRB, per-network-slice, or the like. Thus, downstream information relating to allowed energy usage and/or granularity (e.g., per-UE, per-DRB, per-network-slice, or the like) may be forwarded from the CU to the DU. The downstream information may be for downlink transmissions and/or uplink transmissions.

As shown by reference number 820, the DU may perform an admission (e.g., provide a service to the UE) based on energy usage (e.g., the allowed energy usage) and/or fallback alternatives (e.g., alternative allowed energy usages). In some examples, the DU may indicate the admission to the CU.

As shown by reference number 830, the CU may receive, from the DU, upstream information associated with the energy usage report. For example, the upstream information may contain a report of energy usage (e.g., an amount of energy consumed, mode activation, mode deactivation, or the like). The report may be based on the energy usage report configuration transmitted by the CU. The report may be periodic or event-triggered. The granularity in the upstream information may vary (e.g., the CU may convert the granularity from a DRB to a QoS flow, or the like). The granularity may be per-UE, per-DRB, per-network-slice, or like.

As shown by reference number 840, the MN (which may include the CU and the DU) may transmit, to the SN, downstream information based at least in part on the energy usage monitoring configuration and/or the energy usage report configuration. For example, the downstream information may be relayed from the core network by the MN to the SN. In some examples, the MN may provide a subset of information received from the core network to the SN. For example, the MN may receive energy usage monitoring configurations for every QoS flow, and the MN may forward a subset of the energy usage monitoring configurations based on which QoS flow(s) the SN is handling. The granularity in the downstream information may vary (e.g., the CU may convert the granularity from a QoS flow to DRB, or the like).

As shown by reference number 850, the MN may receive, from the SN, upstream information associated with the energy usage report. For example, the upstream information may contain a report of energy usage (e.g., an amount of energy consumed, mode activation, mode deactivation, or the like). The report may be based on the energy usage report configuration transmitted by the CU. The report may be periodic or event-triggered. The granularity in the upstream information may vary (e.g., the CU may convert the granularity from a DRB to a QoS flow, or the like). The granularity may be per-UE, per-DRB, per-network-slice, or like.

As shown by reference number 860, the CU may transmit the energy usage report to the core network based on the upstream information. In some examples, the upstream information may be relayed to the core network by the CU from the DU. In some examples, the upstream information may be relayed to the core network by the MN from the SN. In some examples, the CU may aggregate reports from the DU and the SN to generate the energy usage report.

The CU transmitting the downstream information to, and receiving the upstream information from, the DU may enable the network node to transmit the energy usage report when the RAN is decomposed into a CU-DU architecture. The MN transmitting the downstream information to, and receiving the upstream information from, the SN may enable the network node to transmit the energy usage report when the RAN is decomposed into an MN-SN architecture.

As indicated above, FIG. 8 is provided as an example. Other examples may differ from what is described with respect to FIG. 8.

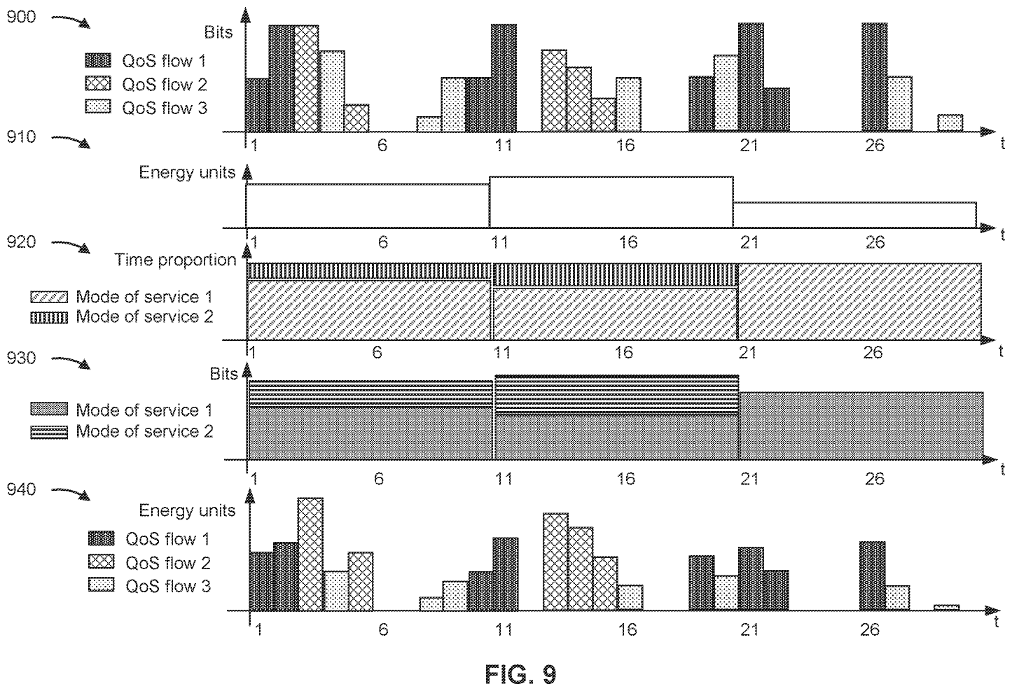

FIG. 9 is a diagram illustrating examples 900-940 associated with reported energy usage information, in accordance with the present disclosure.

Example 900 shows a plot of a data profile of a UE. The data profile includes a quantity of bits consumed by the UE over time using three QoS flows (QoS flow 1, QoS flow 2, and QoS flow 3). Thus, the level of granularity associated with example 900 is a QoS flow.

Examples 910-940 show respective plots of energy profiles for the UE. Examples 910-940 may provide different measures of energy usage for the UE based on example 900.

In some aspects, the energy usage report may indicate an energy usage of the UE over a time window. For instance, example 910 shows the energy usage of the UE over time (e.g., the quantity of Joules consumed by the UE over time).

In some aspects, the energy usage report may indicate an energy usage, associated with a mode of service, of the UE over a time window. For instance, example 920 shows a first proportion of time for which the network node serves the UE using mode of service 1, and a second proportion of time for which the network node serves the UE using mode of service 2.

In some aspects, the energy usage report may indicate a quantity of bits, associated with a mode of service, transmitted to or from the UE over a time window. For instance, example 930 shows a quantity of bits delivered to the UE during mode of service 1 and mode of service 2 in a given time window.

In some aspects, the energy usage report may indicate an energy usage, associated with a QoS flow, of the UE over a time window. For instance, example 940 shows the energy usage at the same level of granularity as in example 900 (e.g., on the level of QoS flow). Example 940 shows the energy usage for the UE over time using the three QoS flows (QoS flow 1, QoS flow 2, and QoS flow 3).

Examples 910-940 provide specific instances of how energy usage may be captured. Additionally, or alternatively, energy usage (or energy efficiency) may be captured for (or refer to): a mode of operation for serving the UE; an amount of consumed energy units (e.g., over a time window); a duration for serving the UE with a given mode; a data rate (or an amount of data over a time duration) to serve the UE normalized by total energy consumption; a data rate (or an amount of data over a time duration) to serve the UE normalized by a total energy consumption at a given energy mode of operation; or a combination thereof.

Furthermore, energy usage (or energy efficiency) may be monitored based on directionality. For example, energy usage may be monitored for directional data (e.g., only energy for downlink data or only energy for uplink data may be monitored) or for bidirectional data (e.g., energy for both downlink data and uplink data may be monitored). Additionally, or alternatively, the energy usage (or energy efficiency) may be monitored based on the type of data. For example, energy usage may be monitored for only user plane data, only control plane data, or both user plane data and control plane data.

As indicated above, FIG. 9 is provided as an example. Other examples may differ from what is described with respect to FIG. 9.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with energy usage reporting by a network node.

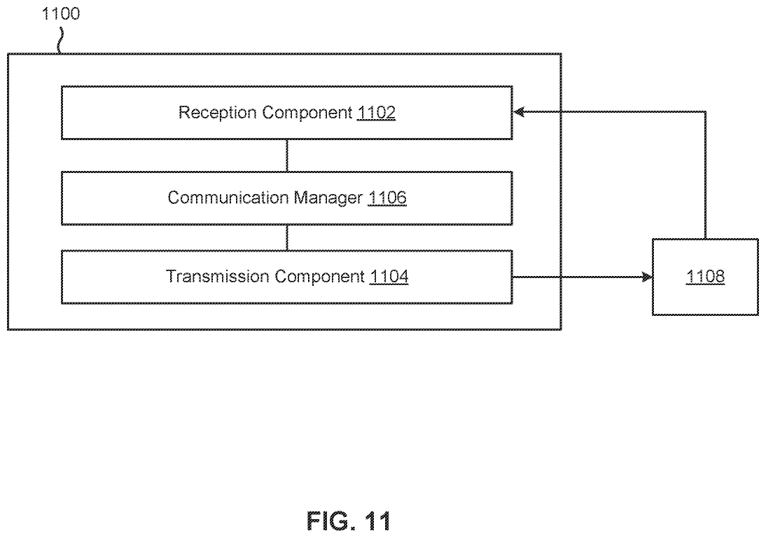

As shown in FIG. 10, in some aspects, process 1000 may include receiving an energy usage monitoring configuration associated with service of a UE (block 1010). For example, the network node (e.g., using reception component 1102 and/or communication manager 1106, depicted in FIG. 11) may receive an energy usage monitoring configuration associated with service of a UE, as described above.

As further shown in FIG. 10, in some aspects, process 1000 may include transmitting to the UE, or receiving from the UE, one or more transmissions (block 1020). For example, the network node (e.g., using reception component 1102, transmission component 1104, and/or communication manager 1106, depicted in FIG. 11) may transmit to the UE, or receive from the UE, one or more transmissions, as described above.

As further shown in FIG. 10, in some aspects, process 1000 may include transmitting, based at least in part on the one or more transmissions, an energy usage report associated with the energy usage monitoring configuration (block 1030). For example, the network node (e.g., using transmission component 1104 and/or communication manager 1106, depicted in FIG. 11) may transmit, based at least in part on the one or more transmissions, an energy usage report associated with the energy usage monitoring configuration, as described above.

Process 1000 may include additional aspects, such as any single aspect or any combination of aspects described below and/or in connection with one or more other processes described elsewhere herein.

In a first aspect, process 1000 includes receiving a threshold indication of an energy usage threshold associated with the energy usage monitoring configuration.

In a second aspect, alone or in combination with the first aspect, the energy usage threshold is specific to the UE.

In a third aspect, alone or in combination with the first aspect, the energy usage threshold is specific to a network slice that is associated with the UE.

In a fourth aspect, alone or in combination with the first aspect, the energy usage threshold is specific to a PDU session.

In a fifth aspect, alone or in combination with the first aspect, the energy usage threshold is specific to a QoS flow.

In a sixth aspect, alone or in combination with one or more of the first through fifth aspects, the energy usage report indicates one or more of a level of granularity associated with the energy usage report, a time associated with the energy usage report, or a triggering event associated with the energy usage report.

In a seventh aspect, alone or in combination with one or more of the first through sixth aspects, process 1000 includes transmitting, by a CU of the network node to a DU of the network node, downstream information based at least in part on the energy usage monitoring configuration, and receiving, by the CU from the DU, upstream information associated with the energy usage report.

In an eighth aspect, alone or in combination with one or more of the first through seventh aspects, the network node is an MN, and process 1000 includes transmitting, to an SN, downstream information based at least in part on the energy usage monitoring configuration, and receiving, from the SN, upstream information associated with the energy usage report.

In a ninth aspect, alone or in combination with one or more of the first through eighth aspects, the energy usage report indicates an energy usage of the UE over a time window.

In a tenth aspect, alone or in combination with one or more of the first through ninth aspects, the energy usage report indicates an energy usage, associated with a mode of service, of the UE over a time window.

In an eleventh aspect, alone or in combination with one or more of the first through tenth aspects, the energy usage report indicates a quantity of bits, associated with a mode of service, transmitted to or from the UE over a time window.

In a twelfth aspect, alone or in combination with one or more of the first through eleventh aspects, the energy usage report indicates an energy usage, associated with a QoS flow, of the UE over a time window.

In a thirteenth aspect, alone or in combination with one or more of the first through twelfth aspects, transmitting the energy usage report includes transmitting the energy usage report based at least in part on one or more of a start of a mode of service, or an energy usage associated with the UE satisfying an energy usage threshold.

In a fourteenth aspect, alone or in combination with one or more of the first through thirteenth aspects, the energy usage report is specific to the UE, a network slice associated with the UE, a PDU session associated with the UE, or a QoS flow associated with the UE.

In a fifteenth aspect, or in combination with one or more of the first through fourteenth aspects, process 1000 includes receiving an energy usage report configuration associated with the energy usage report.

In a sixteenth aspect, or in combination with one or more of the first through fifteenth aspects, process 1000 includes transmitting an indication associated with the energy usage monitoring configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-9. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an energy usage monitoring configuration associated with service of a UE. The transmission component 1104 may transmit to a UE, or the reception component 1102 may receive from the UE, one or more transmissions. The transmission component 1104 may transmit, based at least in part on the one or more transmissions, an energy usage report associated with the energy usage monitoring configuration.

The reception component 1102 may receive a threshold indication of an energy usage threshold associated with the energy usage monitoring configuration.

The transmission component 1104 may transmit downstream information based at least in part on the energy usage monitoring configuration.

The reception component 1102 may receive upstream information associated with the energy usage report.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a network node, comprising: receiving an energy usage monitoring configuration associated with service of a UE; transmitting to the UE, or receiving from the UE, one or more transmissions; and transmitting, based at least in part on the one or more transmissions, an energy usage report associated with the energy usage monitoring configuration.

Aspect 2: The method of Aspect 1, further comprising: receiving a threshold indication of an energy usage threshold associated with the energy usage monitoring configuration.

Aspect 3: The method of Aspect 2, wherein the energy usage threshold is specific to the UE.

Aspect 4: The method of Aspect 2, wherein the energy usage threshold is specific to a network slice that is associated with the UE.

Aspect 5: The method of Aspect 2, wherein the energy usage threshold is specific to a PDU session.

Aspect 6: The method of Aspect 2, wherein the energy usage threshold is specific to a QoS flow.

Aspect 7: The method of any of Aspects 1-6, wherein the energy usage report indicates one or more of a level of granularity associated with the energy usage report, a time associated with the energy usage report, or a triggering event associated with the energy usage report.

Aspect 8: The method of any of Aspects 1-7, further comprising: transmitting, by a CU of the network node to a DU of the network node, downstream information based at least in part on the energy usage monitoring configuration; and receiving, by the CU from the DU, upstream information associated with the energy usage report.

Aspect 9: The method of any of Aspects 1-8, wherein the network node is a MN, the method further comprising: transmitting, to a SN, downstream information based at least in part on the energy usage monitoring configuration; and receiving, from the SN, upstream information associated with the energy usage report.

Aspect 10: The method of any of Aspects 1-9, wherein the energy usage report indicates an energy usage of the UE over a time window.

Aspect 11: The method of any of Aspects 1-10, wherein the energy usage report indicates an energy usage, associated with a mode of service, of the UE over a time window.

Aspect 12: The method of any of Aspects 1-11, wherein the energy usage report indicates a quantity of bits, associated with a mode of service, transmitted to or from the UE over a time window.

Aspect 13: The method of any of Aspects 1-12, wherein the energy usage report indicates an energy usage, associated with a QoS flow, of the UE over a time window.

Aspect 14: The method of any of Aspects 1-13, wherein transmitting the energy usage report includes transmitting the energy usage report based at least in part on one or more of a start of a mode of service, or an energy usage associated with the UE satisfying an energy usage threshold.

Aspect 15: The method of any of Aspects 1-14, wherein the energy usage report is specific to the UE, a network slice associated with the UE, a PDU session associated with the UE, or a QoS flow associated with the UE.

Aspect 16: The method of any of Aspects 1-15, further comprising: receiving an energy usage report configuration associated with the energy usage report.

Aspect 17: The method of any of Aspects 1-16, further comprising: transmitting an indication associated with the energy usage monitoring configuration.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
one or more memories; and
one or more processors, coupled to the one or more memories, which are configured, individually or in any combination, to:
receive an energy usage monitoring configuration associated with service of a user equipment (UE);
transmit to the UE, or receive from the UE, one or more transmissions; and
transmit, based at least in part on the one or more transmissions, an energy usage report associated with the energy usage monitoring configuration.

2. The network node of claim 1, wherein the one or more processors are further configured, individually or in any combination, to:
receive a threshold indication of an energy usage threshold associated with the energy usage monitoring configuration.

3. The network node of claim 2, wherein the energy usage threshold is specific to the UE.

4. The network node of claim 2, wherein the energy usage threshold is specific to a network slice that is associated with the UE.

5. The network node of claim 2, wherein the energy usage threshold is specific to a protocol data unit (PDU) session.

6. The network node of claim 2, wherein the energy usage threshold is specific to a quality of service (QoS) flow.

7. The network node of claim 1, wherein the energy usage report indicates one or more of a level of granularity associated with the energy usage report, a time associated with the energy usage report, or a triggering event associated with the energy usage report.

8. The network node of claim 1, wherein the one or more processors are further configured, individually or in any combination, to:
transmit, by a central unit (CU) of the network node to a distributed unit (DU) of the network node, downstream information based at least in part on the energy usage monitoring configuration; and
receive, by the CU from the DU, upstream information associated with the energy usage report.

9. The network node of claim 1, wherein the network node is a master node (MN), and wherein the one or more processors are further configured, individually or in any combination, to:
transmit, to a secondary node (SN), downstream information based at least in part on the energy usage monitoring configuration; and
receive, from the SN, upstream information associated with the energy usage report.

10. The network node of claim 1, wherein the energy usage report indicates an energy usage of the UE over a time window.

11. The network node of claim 1, wherein the energy usage report indicates an energy usage, associated with a mode of service, of the UE over a time window.

12. The network node of claim 1, wherein the energy usage report indicates a quantity of bits, associated with a mode of service, transmitted to or from the UE over a time window.

13. The network node of claim 1, wherein the energy usage report indicates an energy usage, associated with a quality of service (QoS) flow, of the UE over a time window.

14. The network node of claim 1, wherein the one or more processors, to transmit the energy usage report, are configured, individually or in any combination, to transmit the energy usage report based at least in part on one or more of a start of a mode of service, or an energy usage associated with the UE satisfying an energy usage threshold.

15. The network node of claim 1, wherein the energy usage report is specific to the UE, a network slice associated with the UE, a protocol data unit (PDU) session associated with the UE, or a quality of service (QoS) flow associated with the UE.

16. The network node of claim 1, wherein the one or more processors are further configured, individually or in any combination, to:
receive an energy usage report configuration associated with the energy usage report.

17. The network node of claim 1, wherein the one or more processors are further configured, individually or in any combination, to:
transmit an indication associated with the energy usage monitoring configuration.

18. A method of wireless communication performed by a network node, comprising:
receiving an energy usage monitoring configuration associated with service of a user equipment (UE);
transmitting to the UE, or receiving from the UE, one or more transmissions; and
transmitting, based at least in part on the one or more transmissions, an energy usage report associated with the energy usage monitoring configuration.

19. The method of claim 18, further comprising:
receiving a threshold indication of an energy usage threshold associated with the energy usage monitoring configuration.

20. The method of claim 18, wherein the energy usage report indicates one or more of a level of granularity associated with the energy usage report, a time associated with the energy usage report, or a triggering event associated with the energy usage report.

21. The method of claim 18, further comprising:
transmitting, by a central unit (CU) of the network node to a distributed unit (DU) of the network node, downstream information based at least in part on the energy usage monitoring configuration; and
receiving, by the CU from the DU, upstream information associated with the energy usage report.

22. The method of claim 18, wherein the network node is a master node (MN), the method further comprising:
transmitting, to a secondary node (SN), downstream information based at least in part on the energy usage monitoring configuration; and
receiving, from the SN, upstream information associated with the energy usage report.

23. The method of claim 18, wherein transmitting the energy usage report includes transmitting the energy usage report based at least in part on one or more of a start of a mode of service, or an energy usage associated with the UE satisfying an energy usage threshold.

24. The method of claim 18, wherein the energy usage report is specific to the UE, a network slice associated with the UE, a protocol data unit (PDU) session associated with the UE, or a quality of service (QoS) flow associated with the UE.

25. A non-transitory computer-readable medium storing a set of instructions for wireless communication, the set of instructions comprising:
one or more instructions that, when executed by one or more processors of a network node, cause the network node to:
receive an energy usage monitoring configuration associated with service of a user equipment (UE);
transmit to the UE, or receive from the UE, one or more transmissions; and
transmit, based at least in part on the one or more transmissions, an energy usage report associated with the energy usage monitoring configuration.

26. The non-transitory computer-readable medium of claim 25, wherein the one or more instructions further cause the network node to:
receive a threshold indication of an energy usage threshold associated with the energy usage monitoring configuration.

27. The non-transitory computer-readable medium of claim 25, wherein the one or more instructions further cause the network node to:
transmit, by a central unit (CU) of the network node to a distributed unit (DU) of the network node, downstream information based at least in part on the energy usage monitoring configuration; and
receive, by the CU from the DU, upstream information associated with the energy usage report.

28. The non-transitory computer-readable medium of claim 25, wherein the network node is a master node (MN), and wherein the one or more instructions further cause the network node to:
transmit, to a secondary node (SN), downstream information based at least in part on the energy usage monitoring configuration; and
receive, from the SN, upstream information associated with the energy usage report.

29. An apparatus for wireless communication, comprising:
means for receiving an energy usage monitoring configuration associated with service of a user equipment (UE);
means for transmitting to the UE, or means for receiving from the UE, one or more transmissions; and
means for transmitting, based at least in part on the one or more transmissions, an energy usage report associated with the energy usage monitoring configuration.

30. The apparatus of claim 29, further comprising:
means for receiving a threshold indication of an energy usage threshold associated with the energy usage monitoring configuration.
